(19) United States
(12) Patent Application Publication
(10) Pub. No.: US 2005/0200335 A1
(43) Pub. Date: Sep. 15, 2005

(54) Apparatus

(75) Inventor: Takashi Yano, Asaka (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/073,539

(22) Filed: Mar. 8, 2005

(30) Foreign Application Priority Data
Mar. 9, 2004 (JP) 2004-065783

(51) Int. Cl. H02J 7/00

(52) U.S. Cl. 320/137

(57) ABSTRACT

The present invention provides an apparatus capable of operating with power from a small-sized external power source of which power-supply capacity is small. The apparatus switches among a first switch, a second switch and a third switch so as to use power from an AC adapter as the power for charging a battery and also as the power for operating the apparatus during charging of the battery from the AC adapter by way of a charging control section and during execution of an operation step except for a high power consumption step. The apparatus stops charging the battery to use the power of the battery as the power for operating the apparatus during execution of the high power consumption step.

### BACKGROUND OF THE INVENTION

1. Field of the Invention

The present invention relates to an apparatus for receiving power from a battery to be charged with power from an external power source to operate in multiple operation steps different in power consumption.

2. Description of the Related Art

One of the apparatuses having a built-in battery to be charged with power from an external power source is a digital camera. The digital camera uses the power from an AC adapter as an external power source. If a built-in battery is at a predetermined threshold or less, the camera uses the power from the AC adapter as the power for charging the battery and also uses it as the power for operating the digital camera. In the case where the built-in battery exceeds the predetermined threshold, the camera stops charging the battery and uses the power of the battery or the power from the external power source as the power for operating the digital camera. Furthermore, discharging characteristics of the battery are monitored with a timer in order to sufficiently consume the power of the battery of which charging from the external power source is stopped (refer to Japanese Patent Laid-Open No. 5-236667).

Power-supply capacity of the external power source for supplying the power to the apparatus such as the digital camera is set to sufficiently cover maximum power (peak power) of the apparatus. In the case of the digital camera for instance, the peak power is normally 3 to 4 W (watts) or so so that the power-supply capacity over that peak power is required of the AC adapter. Therefore, the AC adapter is large-sized, which is inconvenient in the case of taking it along on a trip or a business trip.

### SUMMARY OF THE INVENTION

The present invention has been made in view of the above circumstances and provides an apparatus capable of operating with power from a small-sized external power source of which power-supply capacity is small.

The apparatus of the present invention is the one having a built-in battery to be charged with power from an external power source and receiving the power from the built-in battery to operate in multiple operation steps different in power consumption, the apparatus including:
a power consumption determination section that determines whether or not the operation step during operation of the apparatus is a high power consumption step consuming more power than predetermined power; and
a power supply route switching section that switches a power supply route, during charging of the battery from the external power source and during the operation of the apparatus, so as to use the power from the external power source as the power for charging the battery and also as the power for operating the apparatus during execution of the operation step except the high power consumption step, and so as to stop charging the battery to use the power of the battery as the power for operating the apparatus during execution of the high power consumption step.

As for the apparatus for receiving the power from the battery charged with the power from the external power source and operating in operation steps different in power consumption, the operation steps in which the apparatus requires peak power are limited. In the case of a digital camera for instance, such operation steps are limited to shutter operation on shooting and lens driving operation on zooming. The peak power of the digital camera is about 3 to 4 W for instance. Average power is 2 W or so, which is about half the peak power. Here, the operation step which requires the peak power can be predicted in advance. The present invention has been made by paying attention to this point.

The apparatus of the present invention is the one that switches the power supply route so as to use the power from the external power source as the power for charging the battery and also as the power for operating the apparatus during the charging of the battery from the external power source and during execution of the operation step except the high power consumption step. Therefore, it is possible to charge the battery and operate the apparatus with a small amount of external power. And the apparatus switches the power supply route so as to stop charging the battery and use the power of the battery as the power for operating the apparatus during execution of the high power consumption step. Therefore, it is also possible to execute the high power consumption step with a small amount of external power. Thus, the apparatus of the present invention can operate with the power from the small-sized external power source of small power-supply capacity.

Here, it is desirable that the power supply route switching section switch the power supply route so as to stop charging the battery to use the power of the battery as the power for operating the apparatus and also use external power as the power for operating the apparatus during the execution of the high power consumption step.

Thus, it is possible to execute the high power consumption step with a larger amount of external power.

According to the present invention, it is possible to provide the apparatus capable of operating with the power from the small-sized external power source of which power-supply capacity is small.

### BRIEF DESCRIPTION OF THE DRAWINGS

FIG. 1 is an outline perspective view of a digital camera as an embodiment of the present invention viewed from an obliquely upper point in front;

FIG. 2 is an outline perspective view of the digital camera shown in FIG. 1 viewed from an obliquely upper point on the back;

FIG. 3 is a block diagram showing circuitry of the digital camera shown in FIGS. 1 and 2;

FIG. 4 is a diagram showing a power supply route switching section, a power supply system section and a DC/DC converter shown in FIG. 3;

FIG. 5 is a diagram showing operation steps different in power consumption of the digital camera of this embodiment;

FIG. 6 is a diagram showing the states of the first switch, second switch and third switch shown in FIG. 4 at average power and peak power;

FIG. 7 is a diagram showing the circuitry of the power supply system section different from that shown in FIG. 4;

FIG. 8 is a flowchart of a series of control routines for supplying the power for operating the digital camera;

FIG. 9 is a diagram showing the state in which a cradle having the digital camera placed thereon is connected to the personal computer with a USB cable; and

FIG. 10 is a schematic block diagram of the cradle shown in FIG. 9.

### DETAILED DESCRIPTION OF THE INVENTION

Hereunder, an embodiment of the present invention will be described.

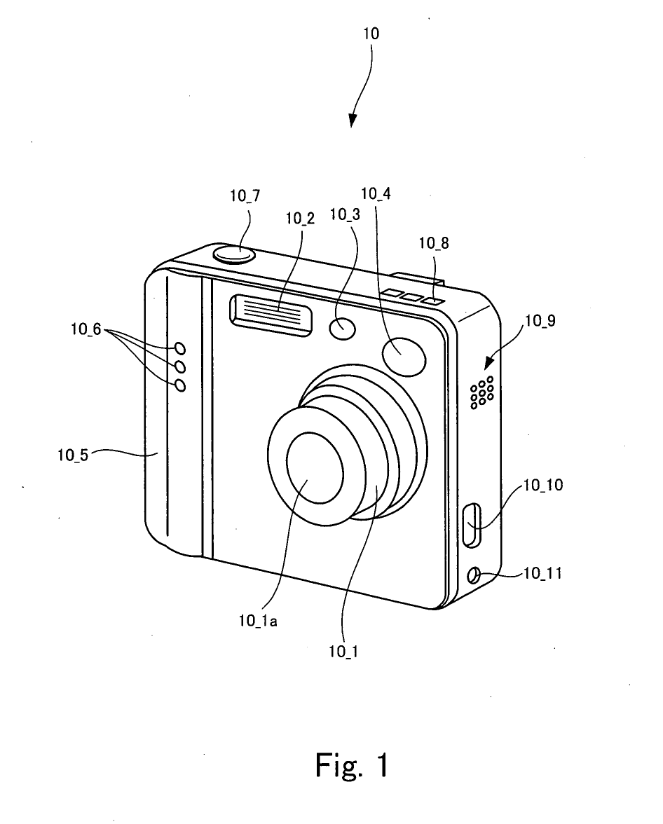

FIG. 1 is an outline perspective view of a digital camera as an embodiment of the present invention viewed from an obliquely upper point in front.

A digital camera 10 shown in FIG. 1 is the digital camera having a built-in battery to be charged with power from an external power source and receiving the power from the built-in battery to operate in multiple operation steps different in power consumption.

The digital camera 10 has a zoom camera cone 10_1 including an image taking lens 10_1a which is an optical zoom lens inside provided at the center of a front face thereof. The digital camera 10 also has a flashlight emitting apparatus 10_2 for emitting flashlight in synchronization with shooting, a flashlight modulation sensor 10_3 for detecting a light volume of the flashlight from the flashlight emitting apparatus 10_2 to control the light volume, and an optical viewfinder object window 10_4 in an upper part of the front face thereof.

The digital camera 10 also has a sliding power switch 10_5 and an illumination lamp 10_6 for lighting up when charging the built-in battery of the digital camera 10 and blinking when transmitting image data and operating a self-timer on a left side of the front face thereof.

Furthermore, the digital camera 10 also has a shutter button 10_7 and a microphone 10_8 for picking up voice on a top face thereof.

The digital camera 10 also has a speaker 10_9, a USB terminal 10_10 for connecting a USB cable used to send shot image data to a personal computer, and an external power supply terminal 10_11 provided on a right side thereof as shown in FIG. 1.

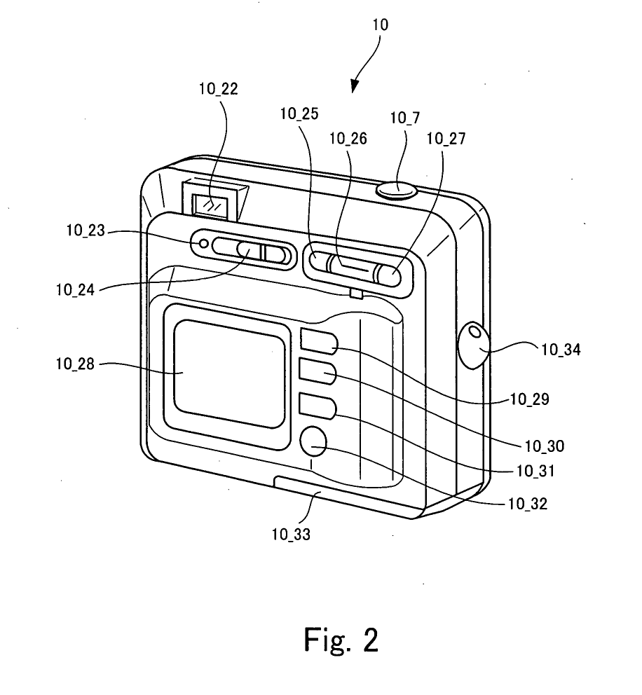

FIG. 2 is an outline perspective view of the digital camera shown in FIG. 1 viewed from an obliquely upper point on the back.

As shown in FIG. 2, the digital camera 10 has an optical viewfinder eye window 10_22, a viewfinder lamp 10_23 for lighting up on completion of shooting preparation and blinking during shooting, and a mode switch 10_24 for switching among a still image mode, a reproduction mode and a video shooting mode provided in the upper part in the back thereof. It also has a macro button 10_25, a zoom button 10_26 and a flash button 10_27 provided on a right side of the mode switch 10_24.

The macro button 10_25 is a button for switching whether or not to perform macro shooting. It goes into a macro shooting mode if the button is pressed once, and the shooting mode is canceled if pressed again.

The zoom button 10_26 is a button for zooming up to a telescopic side if pressed upward and zooming down to a wide-angle side if pressed downward. The zoom button 10_26 is also a button for selecting various menus displayed on a liquid crystal display monitor 10_28 described later merely by pressing it.

The flash button 10_27 is a button for repeatedly switching a flash state each time it is pressed, such as auto flash→red-eye-reduction flash→compulsory flash→flash prohibition→slow shutter flash→auto flash.

The digital camera 10 also has the liquid crystal display monitor 10_28, a MENU/OK button 10_29, a BACK button 10_30, a DISP button 10_31 and a photo mode button 10_32 provided in the center of the backside thereof.

The liquid crystal display monitor 10_28 displays images made of image data generated by capturing object light with the digital camera 10 and information on various settings.

The MENU/OK button 10_29 is a button for displaying various menus on shooting and reproduction and determining the menu selected by the zoom button 10_26.

The BACK button 10_30 is a button for putting an operating state of the MENU/OK button 10_29 and so on back to a state preceding it or canceling it.

The DISP button 10_31 is a button for switching a state of a screen displayed on the liquid crystal display monitor 10_28. It is a button for turning on and off display of the liquid crystal display monitor 10_28 on shooting and turning on and off character display on reproduction.

The photo mode button 10_32 is a button for setting the number of pixels, sensitivity, color and the number of prints.

Furthermore, the digital camera 10 also has an accommodation cover 10_33 for accommodating the battery and a memory card in a lower part in the back thereof. The digital camera 10 also has a strap mounting section 10_34 provided on a side face thereof.

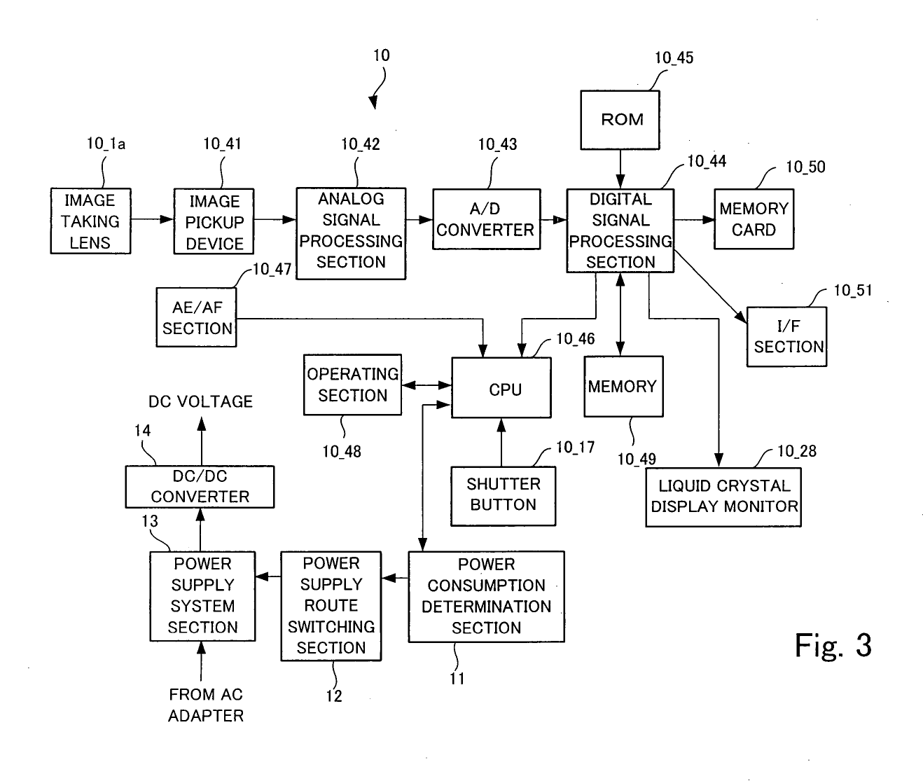

FIG. 3 is a block diagram showing circuitry of the digital camera shown in FIGS. 1 and 2.

The digital camera 10 has the image taking lens 10_1a, and an image pickup device 10_41 for converting an object image provided via the image taking lens 10_1a to analog image signals.

The digital camera 10 also has an analog signal processing section 10_42 for analog-processing the analog image signals from the image pickup device 10_41, an A/D converter 10_43 for A/D converting an analog image signal processed by the analog signal processing section 10_42 to a digital image signal, and a digital signal processing section 10_44 for digital-processing the image signals from the A/D converter 10_43.

Furthermore, the digital camera 10 also has an ROM 10_45 storing program data necessary for the digital processing by the digital signal processing section 10_44, a CPU 10_46 for interacting with the digital signal processing section 10_44, an AE/AF section 10_47 for outputting information for exposure control and focusing control to the CPU 10_46, an operating section 10_48 consisting of the zoom button 10_26 and so on, and the shutter button 10_7 provided thereto.

Moreover, the digital camera 10 also has a memory 10_49 for storing the image data from the digital signal processing section 10_44 and outputting the stored image data to the digital signal processing section 10_44, a memory card 10_50 for storing the image data from the digital signal processing section 10_44, an I/F section 10_51 for sending the image data from the digital signal processing section 10_44 to the personal computer and so on, and the liquid crystal display monitor 10_28 provided thereto.

Furthermore, the digital camera 10 also has a power consumption determination section 11, a power supply route switching section 12, a power supply system section 13 and a DC/DC converter 14 provided thereto.

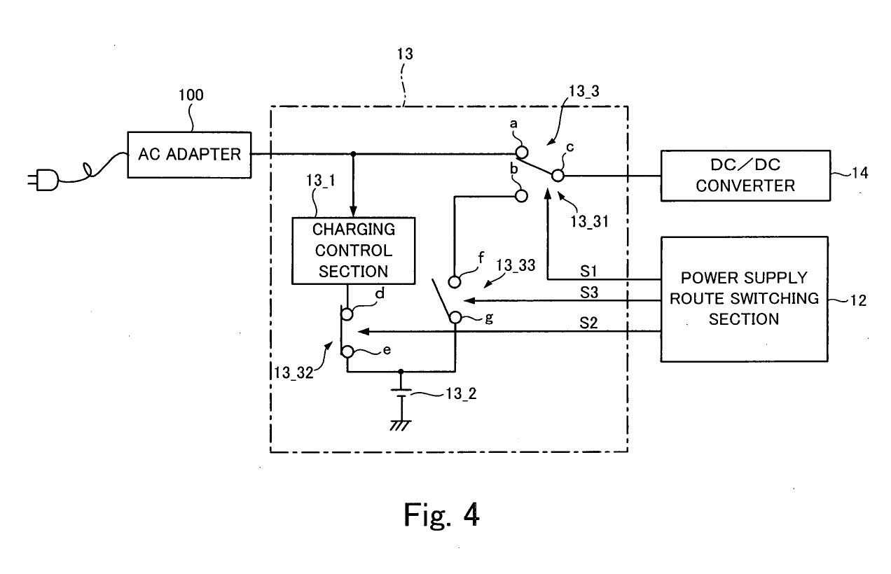

The power consumption determination section 11 exchanges data with the CPU 10_46, and determines whether or not an operation step during the operation of the digital camera 10 is a high power consumption step consuming more power than predetermined power. The power supply route switching section 12, power supply system section 13 and DC/DC converter 14 will be described by referring to FIG. 4.

FIG. 4 is a diagram showing the power supply route switching section, power supply system section and DC/DC converter shown in FIG. 3.

The power supply system section 13 shown in FIG. 4 has an AC adapter 100 as an external power source connected thereto. The power supply system section 13 has a charging control section 13_1, a battery 13_2 and a power supply route 13_3 provided thereto.

The charging control section 13_1 is placed between the AC adapter 100 and the battery 13_2, and controls charging of the battery 13_2.

A secondary battery capable of charging and discharging is used as the battery 13_2.

The power supply route 13_3 consists of a first switch 13_31 having contacts a, b and c, a second switch 13_32 having contacts d and e and a third switch 13_33 having contacts f and g. The first switch 13_31, second switch 13_32 and third switch 13_33 are switched by switch signals S1, S2 and S3 from the power supply route switching section 12.

The power supply route switching section 12 switches among the first switch 13_31, second switch 13_32 and third switch 13_33 as will be described later in detail based on a determination result of the power consumption determination section 11. During the charging of the battery 13_2 from the AC adapter 100 and during the operation of the digital camera 10, the power from the AC adapter 100 is used as the power for charging the battery 13_2 and also used as the power for operating the digital camera 10 when the operation step except for the high power consumption step is executed. In contrast, the charging of the battery 13_2 by the AC adapter 100 is stopped and the power of the battery 13_2 is used as the power for operating the digital camera 10 when the high power consumption step is executed.

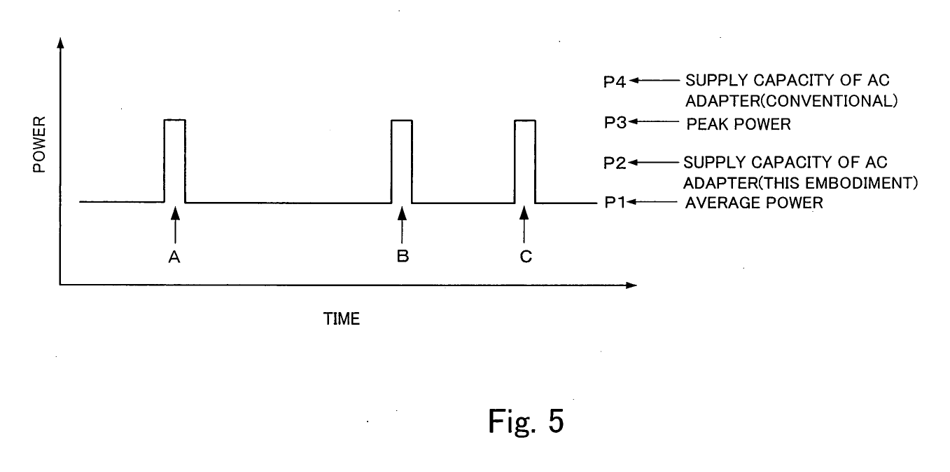

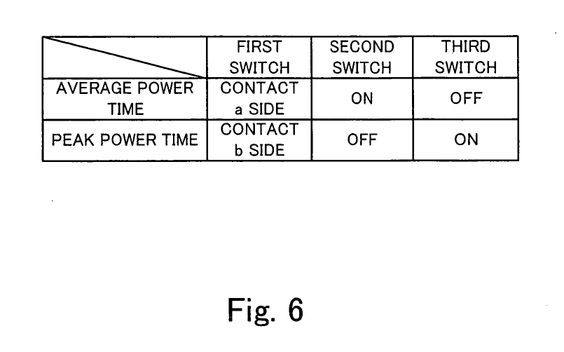

FIG. 5 is a diagram showing the operation steps different in power consumption of the digital camera of this embodiment. FIG. 6 is a diagram showing the states of the first switch, second switch and third switch shown in FIG. 4 at average power and peak power.

As shown in FIG. 5, peak power values P3 of the digital camera 10 are a charging operation time A for emitting the flashlight, a lens driving operation time B on zooming, and a shutter operation time C which are the high power consumption steps. A power value P1 shown in FIG. 5 is an average power value of the digital camera 10. A power value P2 is a power supply capacity value of the AC adapter 100. Furthermore, a power value P4 is the power supply capacity value of a conventional AC adapter designed to sufficiently cover the peak power.

As for the digital camera 10 of this embodiment, on shooting, the power consumption determination section 11 shown in FIG. 3 determines whether or not the operation step during the operation of the digital camera 10 is a high power consumption step consuming more power than predetermined power.

The power supply route switching section 12 receives this determination result, and switches the first switch 13_31 to the contact a side and switches the second switch 13_32 and third switch 13_33 on and off respectively as shown in FIGS. 4 and 6 during the execution of the operation step (operation step at the average power) except the high power consumption steps (the charging operation time A, lens driving operation time B and shutter operation time C). As the second switch 13_32 is switched on, the power from the AC adapter 100 is used as the power for charging the battery 13_2. And as the first switch 13_31 is switched to the contact a side, it is used as the power for operating the digital camera 10 by way of the DC/DC converter 14.

During execution of the high power consumption step (operation step at the peak power), the first switch 13_31 is switched to the contact b side and the second switch 13_32 and third switch 13_33 are switched off and on respectively as shown in FIG. 6. As the second switch 13_32 is switched off, the charging of the battery 13_2 is stopped. As the first switch 13_31 is switched to the contact b side and the third switch 13_33 is switched on, the power of the battery 13_2 is used as the power for operating the digital camera 10.

Thus, the digital camera 10 of this embodiment switches among the first switch 13_31, second switch 13_32 and third switch 13_33 during the charging of the battery 13_2 from the AC adapter 100 and during execution of the operation step except the high power consumption step so as to use the power from the AC adapter 100 as the power for charging the battery 13_2 and also as the power for operating the digital camera 10. Therefore, it is possible to charge the battery 13_2 and operate the digital camera 10 with the power from a small-sized AC adapter 100 of which power-supply capacity is small. During the execution of the high power consumption step, the first switch 13_31, second switch 13_32 and third switch 13_33 are switched so as to stop charging the battery 13_2 to use the power of the battery 13_2 as the power for operating the digital camera 10 during execution of the high power consumption step. Therefore, it is possible to execute the high power consumption step even if the camera is equipped with the small-sized AC adapter 100 of which power-supply capacity is small. Thus, the digital camera 10 of this embodiment can operate with the power from the small-sized AC adapter 100 of which power-supply capacity is small.

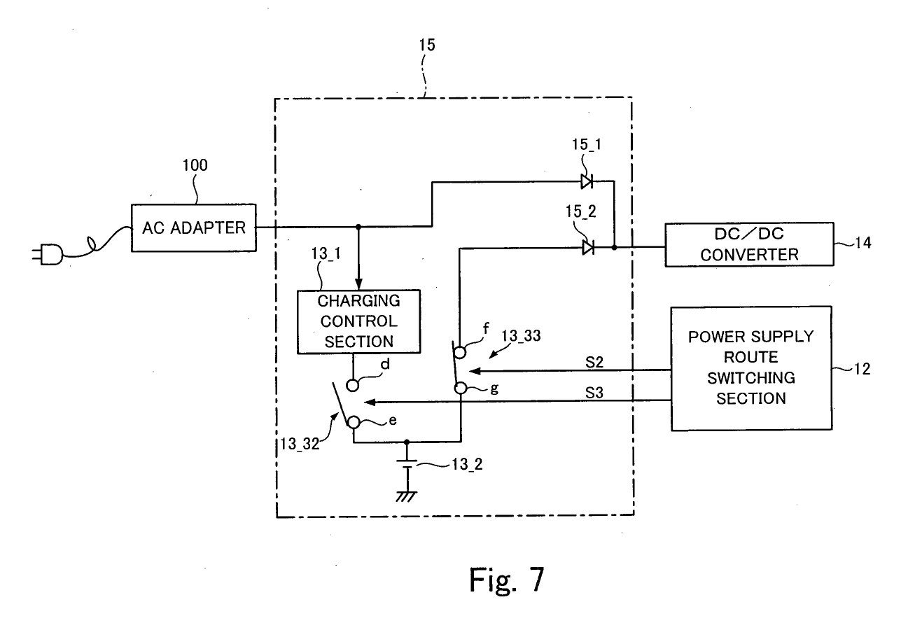

FIG. 7 is a diagram showing the circuitry of the power supply system section different from that shown in FIG. 4.

The circuitry of a power supply system section 15 shown in FIG. 7 is different from that of the power supply system section 13 shown in FIG. 4 in that the first switch 13_31 is deleted and diode elements 15_1 and 15_2 are added.

During the execution of the high power consumption step, the power supply route switching section 12 switches between the second switch 13_32 and third switch 13_33 so as stop charging the battery 13_2 to use the power of the battery 13_2 as the power for operating the digital camera 10 and also use the power from the AC adapter 100 as the power for operating the digital camera 10.

To be more precise, the second switch 13_32 and third switch 13_33 are switched off and on by the switch signals S2 and S3 respectively during the execution of the high power consumption step as shown in FIG. 7. As the second switch 13_32 is switched off, the charging of the battery 13_2 stops. As the third switch 13_33 is switched on, the power of the battery 13_2 is used as the power for operating the digital camera 10 by way of the diode element 15_2. Furthermore, the power from the AC adapter 100 is also used as the power for operating the digital camera 10 by way of the diode element 15_1. Thus, it is possible to execute the high power consumption step with a larger amount of power.

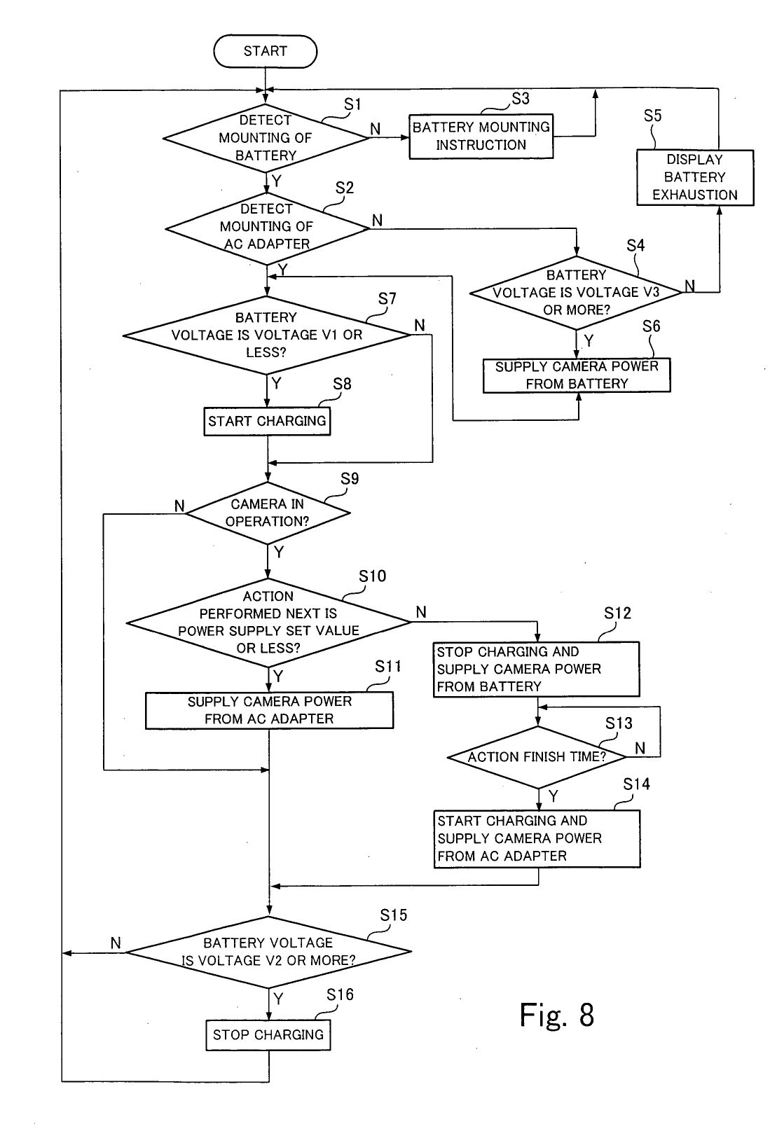

FIG. 8 is a flowchart of a series of control routines for supplying the power for operating the digital camera.

First, in step S1, it is detected whether or not the battery is mounted. In the case where mounting of the battery is detected, it moves on to step S2. In the case where no mounting of the battery is detected, it moves on to step S3. In step S3, a battery mounting instruction is displayed on the liquid crystal display monitor, and it returns to step S1. In this case, it is subject to the AC adapter being mounted.

In step S2, it is detected whether or not the AC adapter is mounted. In the case where no mounting of the AC adapter is detected, it moves on to step S4. In step S4, it is determined whether or not a battery voltage is a voltage V3 or more capable of operating the digital camera. If determined to be less than V3, it displays battery exhaustion in step S5 and returns on to step S1. If determined to be V3 or more, it supplies the power from the battery to the digital camera in step S6 and moves on to step S7.

In the case where the mounting of the AC adapter is detected in step S2, it also moves on to step S7. In step S7, it is determined whether or not the battery voltage is a charging start voltage V1 or less. If determined to be the charging start voltage V1 or less, it starts charging the battery in step S8 and it moves on to step S9. If determined to be exceeding the charging start voltage V1, it moves on as-is to step S9.

In step S9, it is determined whether or not the digital camera is in operation. If determined to be in operation, it moves on to step S10.

In step S10, it is determined whether or not an action to be performed next is a power supply set value (average power value) or less. If determined to be the power supply set value or less, it supplies the power from the AC adapter to the digital camera with the battery charged as-is in step S11 and moves on to step S15 described later. Even when determined that the digital camera is not in operation in step S9, it also moves on to step S15.

If determined to be exceeding the power supply set value in step S10, it moves on to step S12. In step S12, it stops the charging of the battery and supplies the power from the battery to the digital camera so as to move on to step S13. In step S13, it is determined whether or not the action is finished. If determined that the action is not finished, step S13 is repeatedly performed until the action is finished. If determined that the action is finished, it moves on to step S14. In step S14, it starts charging the battery and supplies the power from the AC adapter to the digital camera so as to move on to step S15.

In step S15, it is determined whether or not the battery voltage is a charging stop voltage V2 (full charge voltage) or more. If determined to be less than the charging stop voltage V2, it returns to step S1. If determined to be the charging stop voltage V2 or more, it moves on to step S16. In step S16, it stops the charging of the battery and returns to step S1. In this way, the series of control routines for supplying the power for operating the digital camera is executed.

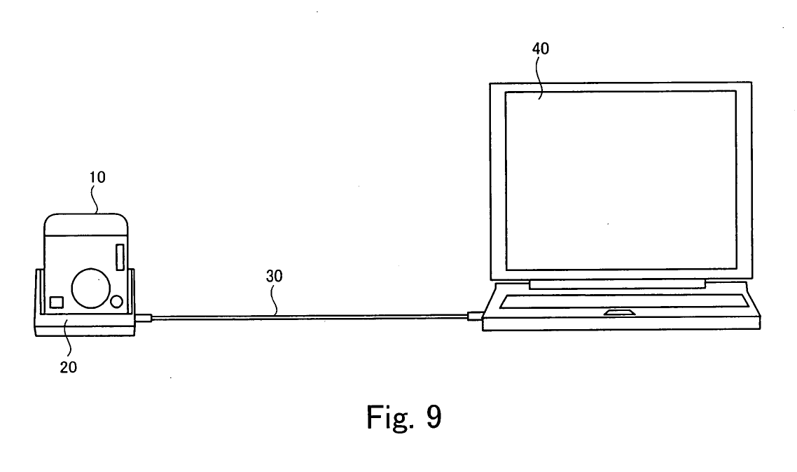

FIG. 9 is a diagram showing the state in which a cradle having the digital camera placed thereon is connected to the personal computer with a USB cable.

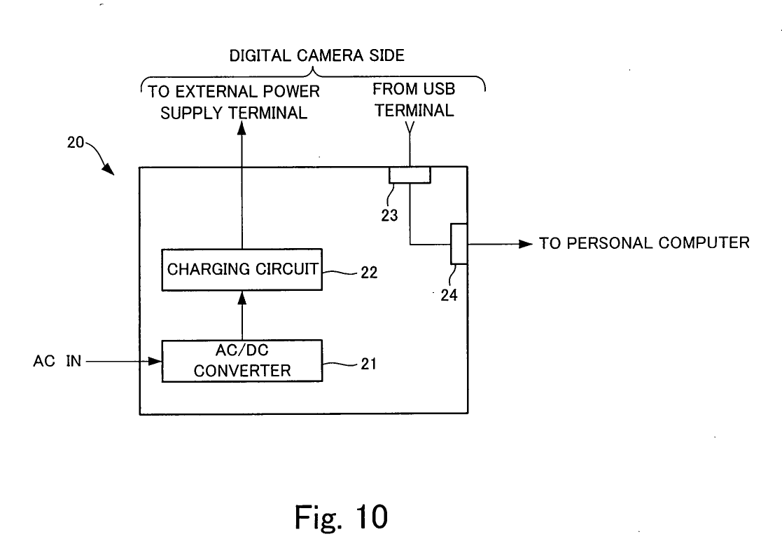

In FIG. 9, the digital camera 10 is placed on a cradle 20 as the external power source. The cradle 20 is connected to a personal computer 40 with a USB cable 30. Here, the cradle 20 will be described by referring to FIG. 10.

FIG. 10 is a schematic block diagram of the cradle shown in FIG. 9.

The cradle 20 shown in FIG. 10 includes an AC/DC converter 21 for inputting a power supply voltage (AC 100V) and converting it to a predetermined DC voltage, and a charging circuit 22 for inputting the DC voltage from the AC/DC converter 21 and charging the battery 13_2 by way of the external power supply terminal provided in the digital camera 10. The cradle 20 also includes a USB connecter 23 for inputting image data from a USB terminal provided in the digital camera 10 and a USB connecter 24 connected to the USB connecter 23 for exchanging the image data with the personal computer 40.

There are the cases where it places the digital camera 10 on the cradle 20 and sends the image data obtained by shooting with the digital camera 10 to the personal computer 40 via the USB cable 30 while charging the built-in battery 13_2 of the digital camera 10 to perform editing work, such as checking it on the personal computer 40 or deleting the image data of the digital camera 10 according to an instruction from the personal computer 40.

In such cases, the power supply route 13_3 is switched so as to use the power from the cradle 20 as the power for charging the battery 13_2 and also as the power for operating the digital camera 10 during the charging of the battery 13_2 from the cradle 20 and during execution of the operation step except the high power consumption step (a standby state in which no communication by way of the USB cable 30 is performed, for instance). It is thereby possible to maintain the charging of the battery 13_2 as well as the standby state with the power from the small cradle 20 of which power-supply capacity is small. During the execution of the high power consumption step (a state in which the communication by way of the USB cable 30 is performed, for instance), the power supply route 13_3 is switched so as to stop charging the battery 13_2 to use the power of the battery 13_2 as the power for image data communication. It is thereby possible to perform the image data communication with the power from the small cradle 20 of which power-supply capacity is small.

The embodiment of the present invention has been described by exemplifying the digital camera as the apparatus thereof. However, the present invention is not limited thereto but may also be a portable apparatus such as a cell-phone with a camera function or a PDA growing popular in recent years.

1. An apparatus having a built-in battery to be charged with power from an external power source and receiving the power from the built-in battery to operate in a plurality of operation steps different in power consumption, the apparatus comprising:
a power consumption determination section that determines whether or not the operation step during operation of the apparatus is a high power consumption step consuming more power than predetermined power; and
a power supply route switching section that switches a power supply route, during charging of the battery from the external power source and during the operation of the apparatus, so as to use the power from the external power source as the power for charging the battery and also as the power for operating the apparatus during execution of the operation step except the high power consumption step, and so as to stop charging the battery to use the power of the battery as the power for operating the apparatus during execution of the high power consumption step.

2. The apparatus according to claim 1, wherein the power supply route switching section switches a power supply route so as to stop charging the battery to use the power of the battery as the power for operating the apparatus and also use external power as the power for operating the apparatus during the execution of the high power consumption step.
